(19) United States
(12) Patent Application Publication
(10) Pub. No.: US 2007/0132795 A1
(43) Pub. Date: Jun. 14, 2007

(54) APPARATUS AND METHOD OF CONTROLLING POWER SUPPLIED TO A PRINTER HEAD AND AN IMAGE FORMING DEVICE HAVING THE SAME

(76) Inventor: Chun-ku Han, Seoul (KR)

Correspondence Address: STANZIONE & KIM, LLP, 919 18TH STREET, N.W., SUITE 440, WASHINGTON, DC, 20006, US

(21) Appl. No.: 11/532,658

(22) Filed: Sep. 18, 2006

(30) Foreign Application Priority Data
Dec. 10, 2005 (KR) 2005-121246

(51) Int. Cl. B41J 29/38

(52) U.S. Cl. 347/9

(57) ABSTRACT

An apparatus and method of controlling power supplied to a printer head included in an image forming device. The apparatus includes a power supply unit to supply DC power to the printer head, a capacitor connected to a power supply terminal of the printer head to stabilize the DC power supplied to the printer head, a discharger to discharge the capacitor, a controller to drive the power supply unit by generating a power signal of a first predetermined value and a discharge signal of a second predetermined value to supply the power to the printer head, and to drive the discharger by generating the power signal of a third predetermined value and the discharge signal of a fourth predetermined signal not to supply the power to the printer head, and a head locker to lock the printer head so that the printer head cannot be disassembled from the image forming device while the power is being supplied to the printer head. Accordingly, by controlling an operation of a device supplying power to the printer head and an operation of a device discharging a capacitor according to a combination of a power signal and a discharge signal generated by a CPU and locking the printer head until the capacitor is sufficiently discharged so that the printer head cannot be disassembled from the image forming device, the capacitor can be safely and quickly discharged when the supply of power to the printer head is stopped, thereby preventing the printer head and/or a printing system from being damaged due to electrical charges remaining in the capacitor.

### CROSS-REFERENCE TO RELATED APPLICATIONS

This application claims the benefit of Korean Patent Application No. 10-2005-0121246, filed on Dec. 10, 2005, in the Korean Intellectual Property Office, the disclosure of which is incorporated herein in its entirety by reference.

### BACKGROUND OF THE INVENTION

1. Field of the Invention

The present general inventive concept relates to an apparatus and method of controlling power supplied to a printer head of an image forming device, and more particularly, to an apparatus and method of preventing a printer head and a printing system from being damaged by discharging a capacitor connected to a power supply terminal of the printer head when the supply of power is stopped.

2. Description of the Related Art

In general, an image forming device converts a document edited by a user using an application program or an image photographed by a user using a digital camera into encoded data and prints the encoded data on a medium in a visually recognizable format.

The image forming device includes a printer head having a plurality of recording elements for forming an image on the medium. When using an inkjet printer having a printer head including a plurality of nozzles, an image is printed by the plurality of nozzles that eject ink on the medium. In order to make each of the plurality of nozzles eject ink on the medium, power of a predetermined value must be supplied to the printer head. Thus, in general, the image forming device includes a power supply control apparatus for supplying constant power to the printer head regardless of an operational state.

FIG. 1 is a block diagram illustrating a conventional apparatus for controlling power supplied to a printer head 140. Referring to FIG. 1, the conventional power supply control apparatus includes a central processing unit (CPU) 100, a power controller 110, a pulse width modulation integrated circuit (PWM-IC) 120, an over-current protector 130, and a capacitor 150.

The CPU 100 generates a power signal for controlling power supplied to the printer head 140 according to an operation of an image forming device, and the power controller 110 drives the PWM-IC 120 according to the generated power signal. That is, in a printing job of the image forming device, the CPU 100 generates a high power signal, and the power controller 110 receives the power signal and drives the PWM-IC 120 according to the received power signal. The power controller 110 controls the PWM-IC 120 to convert input AC power to DC power.

In the printing job, the printer head 140 may be overloaded or damaged because of an abnormal operation due to physical actions, or a peripheral circuit may be damaged. Thus, the image forming device includes the over-current protector 130 which blocks power exceeding a predetermined allowable limit to prevent the printer head 140 or the peripheral circuit from being damaged.

As illustrated in FIG. 1, the capacitor 150 is connected to a power supply terminal of the printer head 140, so that constant power is supplied to the printer head 140 without abrupt fluctuations.

Recently, image forming devices having an array head structure have been developed to print a high quality image at a high speed without a reciprocating motion of a printer head. In this case, the printer head is the same length as a width of a printing medium. According to a characteristic of an image forming device having the array head structure, many recording elements are included in the printer head which prints the image on the printing medium, thereby significantly increasing power consumption used for printing.

Thus, since a capacitance of the capacitor 150 for stabilizing power supplied to the printer head 140 is typically very high, when a printing job is finished and the supply of power to the printer head 140 is stopped, a very long time is required to discharge the capacitor 150. As a result, if the printer head 140 is disassembled from the image forming device before the capacitor 150 is fully discharged, the printer head 140 and/or a corresponding peripheral circuit may be damaged, or a user safety hazard may occur.

### SUMMARY OF THE INVENTION

The present general inventive concept provides an apparatus and method of controlling power supplied to a printer head of an image forming device by quickly and safely discharging a capacitor.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an apparatus to control power supplied to a printer head of an image forming device, the apparatus including a power supply unit to supply DC power to the printer head, a capacitor connected to a power supply terminal of the printer head to stabilize the DC power supplied to the printer head, a discharger to discharge the capacitor, a controller to drive the power supply unit by generating a power signal of a first predetermined value and a discharge signal of a second predetermined value to supply the power to the printer head, and to drive the discharger by generating the power signal of a third predetermined value and the discharge signal of a fourth predetermined signal not to supply the power to the printer head, and a head locker to lock the printer head so that the printer head cannot be disassembled from the image forming device while the power is being supplied to the printer head.

The head locker may unlock the printer head so that the printer head is removable from the image forming device if a voltage of the power supply terminal of the printer head is equal to or lower than a predetermined value.

The discharger may be driven by an auxiliary voltage source, a system voltage source, and a printer head supply voltage source.

The controller may include a central processing unit (CPU) to generate the power signal and the discharge signal as ‘high’ and ‘low’, respectively, to supply the power to the printer head, and to generate the power signal and the discharge signal as ‘low’ and ‘high’, respectively, not to supply the power to the printer head, and a power controller to generate a signal to drive the power supply unit when the power signal is ‘high’ and the discharge signal is ‘low’ and a signal to drive the discharger when the power signal is ‘low’ and the discharge signal is ‘high.’

The head locker may include a solenoid locker to lock the printer head in the image forming device using a solenoid, and a locker driver to detect a voltage of the power supply terminal of the printer head and to drive the solenoid locker so that the printer head cannot be disassembled from the image forming device when the detected voltage exceeds a predetermined value.

The locker driver may drive the solenoid locker by controlling a current to flow to the solenoid.

The foregoing and/or other aspects of the present general inventive concept are also achieved by providing an image forming device powered by a system power, the device including a printer head to form an image, a capacitor connected to an input terminal of the printer head to stabilize a voltage applied thereto, and a power supply control unit to power on and power off the printer head by charging and discharging the voltage on the capacitor while the device is powered on by the system power.

The foregoing and/or other aspects of the present general inventive concept are also achieved by providing an image forming device, including a printer head to form an image, a power supply control unit to supply power to the printer head, a capacitor connected between the power supply control unit and the printer head and to charge and discharge according to the power supplied to the printer head, and a head locker to sense a power level charged on the capacitor and to prevent the printer head from being removed from the device when the sensed power level is greater than a predetermined level.

The foregoing and/or other aspects of the present general inventive concept are also achieved by providing a power supply control apparatus usable in an image forming device having a printer head with a stabilizing capacitor at an input terminal thereof, the apparatus including a power supply to provide a power to the input terminal of the printer head, a discharger to discharge the stabilizing capacitor, and a power controller to output a power control signal and a discharge control signal to the power supply and the discharger, respectively, to power on the printer head during a first predetermined time and to discharge the stabilizing capacitor during a second predetermined time, the first and second predetermined times being determined by a printing cycle.

The foregoing and/or other aspects of the present general inventive concept are also achieved by providing a method of controlling power supplied to a printer head of an image forming device, the method including receiving a power signal and a discharge signal from a central processing unit (CPU), supplying the power to the printer head when the received power signal has a first predetermined value and the received discharge signal has a second predetermined value, and discharging a capacitor connected to a power supply terminal of the printer head when the received power signal has a third predetermined value and the received discharge signal has a fourth predetermined value, and locking the printer head so that the printer head cannot be disassembled from the image forming device while the power is being supplied to the printer head.

The method may further include unlocking the printer head so that the printer head is removable from the image forming device if a voltage of the power supply terminal of the printer head is equal to or lower than a predetermined value.

The first predetermined value may be ‘high,’ the second predetermined value may be ‘low,’ the third predetermined value may be ‘low,’ and the fourth predetermined value may be ‘high.’ The locking of the printer head may include detecting a voltage of the power supply terminal of the printer head, and locking the printer head so that the printer head cannot be disassembled from the image forming device when the detected voltage exceeds a predetermined value.

In the locking of the printer head, the printer head may be locked not to be disassembled from the image forming device by controlling a current to flow to a solenoid.

The foregoing and/or other aspects of the present general inventive concept are also achieved by providing a method of controlling a power supply in an image forming device having a printer head, a power supply to provide power to the printer head, a stabilizing capacitor disposed between the power supply and the printer head, a discharger to discharge the capacitor, and a head locker, the method including controlling the power supply to supply the power to the printer head and controlling the discharger not to discharge the stabilizing capacitor such that a printing operation is performed, and when the printing operation is complete, controlling the power supply to stop providing power to the printer head and controlling the discharger to discharge the stabilizing capacitor.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a conventional apparatus for controlling power supplied to a printer head;

FIG. 2 is a block diagram illustrating an apparatus to control power supplied to a printer head according to an embodiment of the present general inventive concept;

FIG. 3 illustrates a circuit diagram of a power controller of the power supply control apparatus of FIG. 2, according to an embodiment of the present general inventive concept;

FIG. 4 illustrates a circuit diagram of a discharger of the power supply control apparatus of FIG. 2, according to an embodiment of the present general inventive concept;

FIG. 5 is flowchart illustrating a method of controlling power supplied to a printer head according to an embodiment of the present general inventive concept;

FIG. 6A and 6B illustrate a configuration of a solenoid locker of the power supply control apparatus of FIG. 2, according to an embodiment of the present general inventive concept; and

FIG. 7 illustrates an image forming device according to an embodiment of the present general inventive concept.

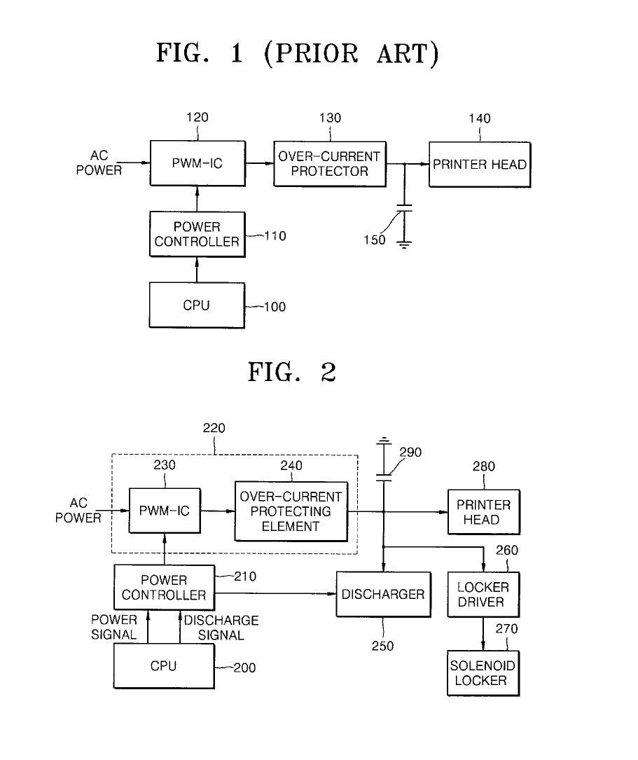

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram illustrating an apparatus to control power supplied to a printer head 280 according to an embodiment of the present general inventive concept. The power supply control apparatus includes a CPU 200, a power controller 210, a power supply unit 220 including a pulse width modulation integrated circuit (PWM-IC) 230 and an over-current protecting element 240, a discharger 250, a locker driver 260, a solenoid locker 270, and a capacitor 290. An operation of the power supply control apparatus illustrated in FIG. 2 will now be described in conjunction with a method of controlling power supplied to the printer head 280 according to an embodiment of the present general inventive concept illustrated in FIG. 5.

Referring to FIGS. 2 and 5, when a printing start request is input in operation 500, the CPU 200 generates a high power signal and a low discharge signal to supply power to the printer head 280 in operation 510. In operation 520, the power controller 210 receives the generated signals and generates a signal to drive the PWM-IC 230. The power supply unit 220, which receives the generated signal, converts AC power to DC power and supplies the converted DC power to the printer head 280.

The PWM-IC 230 converts the AC power to the DC power using a PWM scheme. The over-current protecting element 240 blocks the supply of power exceeding a pre-set allowable limit so that the printer head 280 or a corresponding peripheral circuit is not damaged due to over-power.

When the power controller 210 receives the high power signal and the low discharge signal, the power controller 210 does not drive the discharger 250. That is, when the power controller 210 receives the high power signal and the low discharge signal, the power controller 210 controls the discharger 250 not to discharge the capacitor 290.

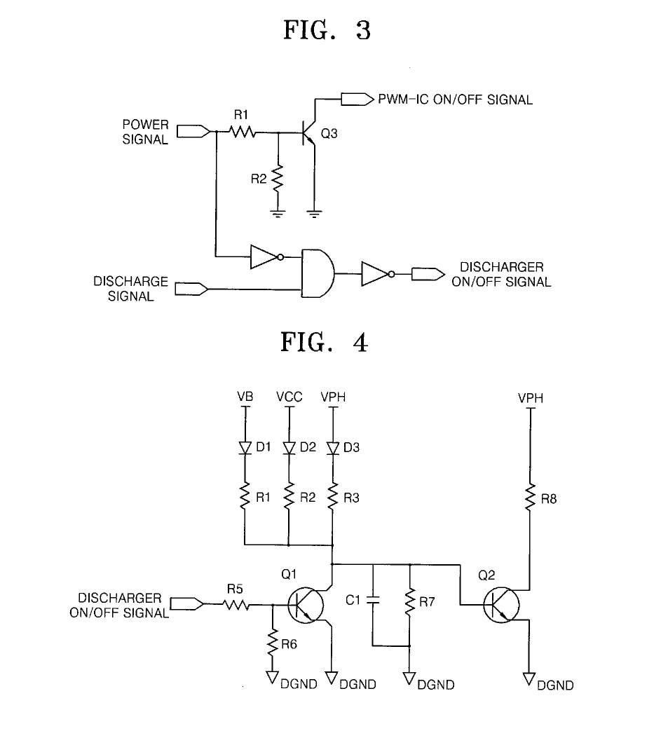

FIG. 3 illustrates a circuit diagram of the power controller 210 of FIG. 2. If the power signal input from the CPU 200 is ‘high’ and the discharge signal is ‘low,’ a ‘PWM IC ON/OFF’ signal output from the power controller 210 illustrated in FIG. 3 is ‘low,’ thereby driving the PWM-IC 230, and a ‘discharger ON/OFF’ signal output from the power controller 210 illustrated in FIG. 3 is ‘high,’ thereby stopping an operation of the discharger 250. That is, in the present embodiment, the PWM-IC 230 and the discharger 250 are active low.

According to the operations described above, the capacitor 290 is charged while printing.

If a voltage of a power supply terminal of the printer head 280 exceeds a threshold voltage Vₜₕ while supplying power to the printer head 280, in operation 530, the locker driver 260 drives the solenoid locker 270 to lock the printer head 280 so that the printer head 280 cannot be disassembled from a main body of an image forming device. That is, the solenoid locker 270 locks the printer head 280 in the main body of the image forming device so that the printer head 280 cannot be accidentally disassembled from the main body of the image forming device or purposefully disassembled from the image forming device by a user.

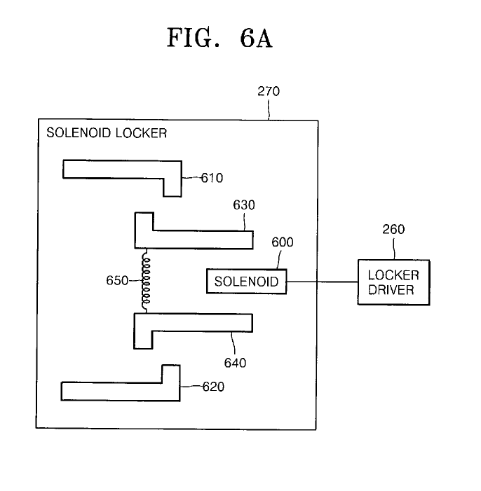

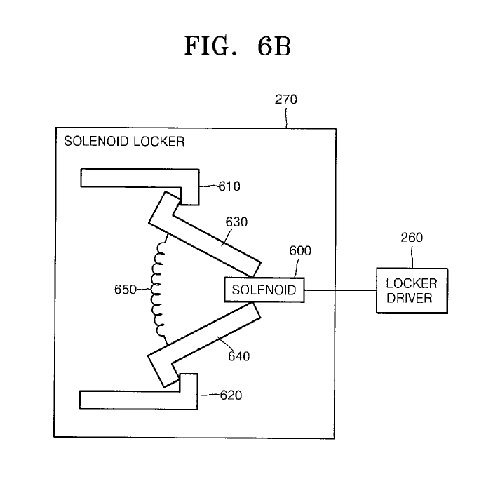

FIG. 6A illustrates a configuration of the solenoid locker 270 of FIG. 2. The locker driver 260 drives the solenoid locker 270 to perform a locking operation by supplying a current to a solenoid 600 and unlocks the solenoid locker 270 by blocking the current supplied to the solenoid 600. Reference numbers 630 and 640 represent metal portions of the printer head 280, reference numbers 610 and 620 represent portions of the main body of the image forming device, and reference number 650 represents a spring. The metal portions 630 and 640 of the printer head 280 may be made partially or entirely of metal. For example, the metal portions 630 and 640 may have a first material with a strip of a second metal material disposed thereon. Other arrangements of the metal portions 630 and 640 may alternatively be used in the solenoid locker 270.

The solenoid 600 is a coil formed by wrapping a conducting wire in a cylindrical shape. If the current flows through the coil, a magnetic field is generated. An intensity H of the magnetic field around a center of the coil is mIl/2r2+(l/2)2 in MKSA (meter-kilogram-second-ampere) unit, wherein r represents a radius of the solenoid 600, l represents a length, n represents the number of windings per unit length, and I represents the current. The solenoid 600 has the properties of a magnet only when the current flows therethrough (i.e., only when the magnetic field is generated by the current).

FIG. 6B illustrates the locking operation of the solenoid locker 270 of FIG. 6A. The solenoid locker 270 locks the printer head 280 in the main body of the image forming device when the locker driver 260 supplies the current to the solenoid 600. As illustrated in FIG. 6B, if the locker driver 260 supplies the current to the solenoid 600, the metal portions 630 and 640 of the printer head 280 adhere to the solenoid 600 which has the properties of a magnet due to the current flowing therethrough. Then, the metal portions 630 and 640 of the printer head 280 engage the portions 610 and 620 of the main body of the image forming device, thereby locking the printer head 280 so that the printer head 280 cannot be disassembled from the main body of the image forming device.

If the locker driver 260 stops supplying the current to the solenoid 600, the solenoid 600 stops acting as a magnet, and therefore, the metal portions 630 and 640 of the printer head 280 return to the original positions (see FIG. 6A) due to elasticity of the spring 650 connected to the metal portions 630 and 640, thereby unlocking the printer head 280. The intensity H of the magnetic field generated by the solenoid 600 is enough to overcome the elasticity in the spring 650 when the current is supplied by the locker driver 260.

Referring to FIGS. 2 and 5, when the printing is finished in operation 540, the CPU 200 generates a low power signal and a high discharge signal in operation 550. In operation 560, the power controller 210 receives the generated signals and generates a signal to stop driving the PWM-IC 230. The power supply unit 220, which receives the driving stop signal, stops the supply of the power to the printer head 280. In operation 570, the power controller 210 receives the generated signals and generates a signal to drive the discharger 250. The discharger 250, which receives the driving signal, discharges electrical charges charged in the capacitor 290.

Referring to FIG. 3, if the power signal input form the CPU 200 is ‘low’ and the discharge signal is ‘high,’ the ‘PWM IC ON/OFF’ signal output from the power controller 210 illustrated in FIG. 3 is ‘high,’ thereby stopping the driving of the PWM-IC 230, and the ‘discharger ON/OFF’ signal output from the power controller 210 illustrated in FIG. 3 is ‘low,’ thereby driving the discharger 250.

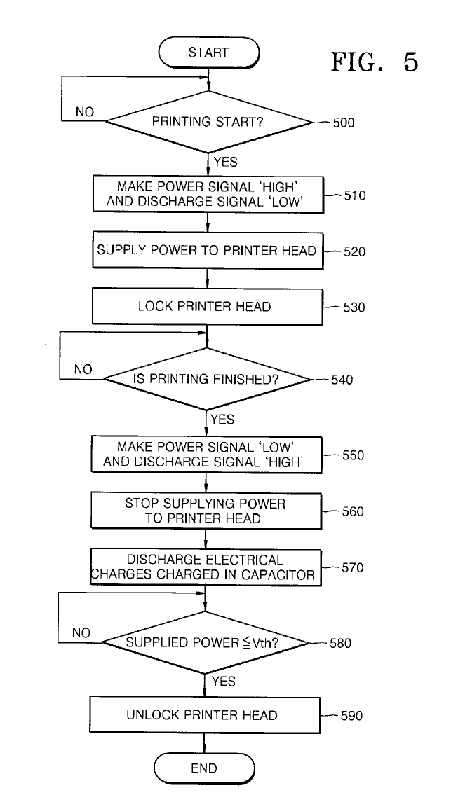

FIG. 4 is a circuit diagram illustrating the discharger 250 of FIG. 2. As illustrated in FIG. 4, the discharger 250 is driven by an auxiliary voltage source VB, a system voltage source VCC, and power supplied to the printer head VPH. If the ‘discharger ON/OFF’ signal input from the power controller 210 is ‘low,’ a transistor Q1 is turned on, thereby dividing a voltage supplied by the auxiliary voltage source VB, the system voltage source VCC, and the power supplied to the printer head VPH by resistors R1, R2, and R3. Accordingly, a discharge transistor Q2 is turned on, thereby discharging the electrical charges charged in the capacitor 290 through a resistor R8.

The discharger 250 illustrated in FIG. 4 can discharge the capacitor 290 not only when the supply of power to the printer head 280 is normally stopped after the printing is finished, as described above, but also when the system voltage source VCC is abnormally blocked. For example, the system voltage source VCC may be abnormally blocked when a plug of the image forming device is suddenly pulled from a power outlet, or if a system power suddenly fails for some other reason. In the discharger 250 illustrated in FIG. 4, if the system voltage source VCC is off, the ‘discharger ON/OFF’ signal is naturally ‘low,’ and the transistor Q1 is turned on by the auxiliary voltage source VB although the system voltage source VCC is off. As a result, a voltage supplied by the auxiliary voltage source VB and the power supplied to the printer head VPH are divided by resistors R1 and R3, thereby turning on the discharge transistor Q2 and discharging the electrical charges charged in the capacitor 290 through the resistor R8.

The auxiliary voltage source VB may be a battery or a super cap (power capacitor) independent from the system voltage source VCC.

When the electrical charges charged in the capacitor 290 are discharged by the discharger 250, the voltage supplied to the printer head 280 decreases. Referring to FIGS. 2 and 5, in operation 580, the locker driver 260 senses the voltage of the power supply terminal of the printer head 280 and determines whether the voltage supplied to the printer head 280 is equal to or lower than the threshold voltage Vₜₕ.

If the voltage supplied to the printer head 280 is equal to or lower than the threshold voltage Vₜₕ, the locker driver 260 stops the driving of the solenoid locker 270 so that the solenoid locker 270 unlocks the printer head 280 in operation 590. If the solenoid locker 270 unlocks the printer head 280, a user can freely disassemble (i.e., remove) the printer head 280 from the main body of the image forming device.

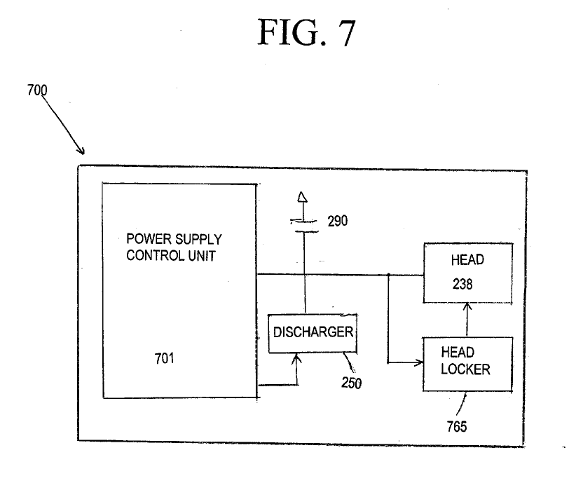

FIG. 7 illustrates an image forming device 700 according to an embodiment of the present general inventive concept. The image forming device 700 may include some components illustrated and described in previous embodiments. The image forming device 700 includes a power supply control unit 701, the capacitor 290 (similar to FIG. 2), the discharger 250 (similar to FIG. 2), the printer head 238 (similar to FIG. 2), and a head locker 765. The power supply control unit 701 may perform functions that are similar to the functions of the power supply unit 220, the power controller 210, and the CPU 200 illustrated in FIG. 2, while the head locker 765 may perform functions that are similar to the functions of the locker driver 260 and the solenoid locker 270 also illustrated in FIG. 2.

The power supply control unit 701 controls (1) a power supplied to the printer head 238 and (2) the operation of the discharger 250. The power supply control unit 701 may operate between a power supply mode and a discharging mode. The power supply control unit 701 can operate in the power supply mode to supply the power to the printer head 238 while a printing operation is being performed by the image forming device 700. On the other hand, the power supply control unit 701 can operate in the discharging mode to discharge the capacitor 290 when the printing operation is completed and/or when system power to the image forming device 700 is cut off. Based on the operation of the power supply control unit 701, the printer head 238 can be powered on and powered off even though the system power of the image forming device 700 remains on. That is, the printer head 238 may has more than one power state when the system power of the image forming device 700 is on.

Additionally, the head locker 765 locks the printer head 238 in the image forming device 700 until a voltage remaining on the capacitor 290 is reduced to a predetermined level. This prevents the printer head 238 from being removed when too high a voltage remains on the capacitor 290, thereby protecting a user from electrical shocks and preventing damage to circuitry.

As described above, in an apparatus and method of controlling power supplied to a printer head of an image forming device according to embodiments of the present general inventive concept, by controlling an operation of a device supplying power to the printer head and an operation of a device that discharges electrical charges charged in a capacitor according to a combination of a power signal and a discharge signal generated by a CPU, when the supply of power to the printer head is stopped, the capacitor can be safely and quickly discharged. In addition, by locking the printer head until the capacitor is sufficiently discharged so that the printer head cannot be disassembled from the image forming device, the printer head and/or a printing system can be prevented from being damaged due to electrical charges remaining in the capacitor, and an occurrence of a user safety hazard can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to control power supplied to a printer head of an image forming device, the apparatus comprising:
a power supply unit to supply DC power to the printer head;
a capacitor connected to a power supply terminal of the printer head to stabilize the DC power supplied to the printer head;
a discharger to discharge the capacitor;
a controller to drive the power supply unit by generating a power signal of a first predetermined value and a discharge signal of a second predetermined value to supply the power to the printer head, and to drive the discharger by generating the power signal of a third predetermined value and the discharge signal of a fourth predetermined signal not to supply the power to the printer head; and
a head locker to lock the printer head so that the printer head cannot be disassembled from the image forming device while the power is being supplied to the printer head.

2. The apparatus of claim 1, wherein the head locker unlocks the printer head so that the printer head is removable from the image forming device if a voltage of the power supply terminal of the printer head is equal to or lower than a predetermined value.

3. The apparatus of claim 1, wherein the discharger is driven by an auxiliary voltage source and a system voltage source.

4. The apparatus of claim 1, wherein the discharger is driven by an auxiliary voltage source and the power supplied to the printer head.

5. The apparatus of claim 1, wherein the controller comprises:
a central processing unit (CPU) to generate the power signal and the discharge signal as ‘high’ and ‘low’, respectively, to supply the power to the printer head and to generate the power signal and the discharge signal as ‘low’ and ‘high’, respectively, not to supply the power to the printer head; and
a power controller to generate a signal to drive the power supply unit when the power signal is ‘high’ and the discharge signal is ‘low’ and a signal to drive the discharger when the power signal is ‘low’ and the discharge signal is ‘high.’

6. The apparatus of claim 1, wherein the head locker comprises:
a solenoid locker to lock the printer head in the image forming device using a solenoid; and
a locker driver to detect a voltage of the power supply terminal of the printer head and to drive the solenoid locker so that the printer head cannot be disassembled from the image forming device when the detected voltage exceeds a predetermined value.

7. The apparatus of claim 6, wherein the locker driver drives the solenoid locker by controlling a current to flow to the solenoid.

8. An image forming device powered by a system power, the device comprising:
a printer head to form an image;
a capacitor connected to an input terminal of the printer head to stabilize a voltage applied thereto; and
a power supply control unit to power on and power off the printer head by charging and discharging the voltage on the capacitor while the device is powered on by the system power.

9. The image forming device of claim 8, further comprising:
a discharger to discharge the capacitor based on a control signal from the power supply control unit.

10. The image forming device of claim 8, further comprising:
a head locker to prevent the printer head from being removed from the device when the voltage on the capacitor is greater than a predetermined level.

11. The image forming device of claim 8, wherein the power supply control unit powers off the printer head after a printing operation is completed and when the system power is cut off from the device.

12. An image forming device, comprising:
a printer head to form an image;
a power supply control unit to supply power to the printer head;
a capacitor connected between the power supply control unit and the printer head and to charge and discharge according to the power supplied to the printer head; and
a head locker to sense a power level charged on the capacitor and to prevent the printer head from being removed from the device when the sensed power level is greater than a predetermined level.

13. The image forming device of claim 12, wherein the head locker comprises:
a locker driver to sense the power level charged on the capacitor and to output a current when the sensed power level is greater than the predetermined level; and
a solenoid locker having a solenoid to receive the current from the locker driver and to create a magnetic field to apply a magnetic force on metal portions of the printer head thereby locking the printer head in the device.

14. The image forming device of claim 13, wherein the head locker further comprises:
a spring disposed between the metal portions of the printer head and to bias the metal portions in an opposite direction from the magnetic force such that the metal portions of the printer head are restored to an original position once the magnetic force is no longer applied.

15. A power supply control apparatus usable in an image forming device having a printer head with a stabilizing capacitor at an input terminal thereof, the apparatus comprising:
a power supply to provide a power to the input terminal of the printer head;
a discharger to discharge the stabilizing capacitor; and
a power controller to output a power control signal and a discharge control signal to the power supply and the discharger, respectively, to power on the printer head during a first predetermined time and to discharge the stabilizing capacitor during a second predetermined time, the first and second predetermined times being determined by a printing cycle.

16. A method of controlling power supplied to a printer head of an image forming device, the method comprising:
receiving a power signal and a discharge signal from a central processing unit (CPU);
supplying the power to the printer head when the received power signal has a first predetermined value and the received discharge signal has a second predetermined value, and discharging a capacitor connected to a power supply terminal of the printer head when the received power signal has a third predetermined value and the received discharge signal has a fourth predetermined value; and
locking the printer head so that the printer head cannot be disassembled from the image forming device while the power is being supplied to the printer head.

17. The method of claim 16, further comprising:
unlocking the printer head so that the printer head is removable from the image forming device if a voltage of the power supply terminal of the printer head is equal to or lower than a predetermined value.

18. The method of claim 16, wherein the first predetermined value is ‘high,’ the second predetermined value is ‘low,’ the third predetermined value is ‘low,’ and the fourth predetermined value is ‘high.’

19. The method of claim 16, wherein the locking of the printer head comprises:
detecting a voltage of the power supply terminal of the printer head; and
locking the printer head so that the printer head cannot be disassembled from the image forming device when the detected voltage exceeds a predetermined value.

20. The method of claim 19, wherein the locking of the printer head comprises locking the printer head so as not to be disassembled from the image forming device by controlling a current to flow to a solenoid.

21. A method of controlling a power supply in an image forming device having a printer head, a power supply to provide power to the printer head, a stabilizing capacitor disposed between the power supply and the printer head, a discharger to discharge the capacitor, and a head locker, the method comprising:
controlling the power supply to supply the power to the printer head and controlling the discharger not to discharge the stabilizing capacitor such that a printing operation is performed; and
when the printing operation is complete, controlling the power supply to stop providing power to the printer head and controlling the discharger to discharge the stabilizing capacitor.

22. The method of claim 21, further comprising:
controlling the head locker to sense a power level in the stabilizing capacitor and to prevent the printer head from being removed from the image forming device when the sensed power level is greater than a predetermined level.
